(19) United States
(12) Patent Application Publication
(10) Pub. No.: US 2008/0198133 A1
(43) Pub. Date: Aug. 21, 2008

(54) Pen-Type Optical Input Device

(76) Inventor: Had-Wen Chen, Taipei (TW)

Correspondence Address: RABIN & Berdo, PC, 1101 14TH STREET, NW, SUITE 500, WASHINGTON, DC, 20005, US

(21) Appl. No.: 11/675,361

(22) Filed: Feb. 15, 2007

(51) Int. Cl. G06F 3/033

(52) U.S. Cl. 345/166

(57) ABSTRACT

The pen-type optical input device of the present invention is utilized for controlling the cursor of operating system of electronic device. The pen-type optical input device comprises a main body, a circuit board and an opaque ball. Therefore, the operational efficiency is improved and the input device is utilized whether the axis plane is transparent or not due to the ball location.

### FIELD OF THE INVENTION

The present invention relates to an input device, and more particularly, to a pen-type optical input device, which is easily grasped with a hand and obviated the limit of light reflection when used.

### BACKGROUND OF THE INVENTION

Computers have become the most important tool and been used to interact with users in daily routine, more and more jobs require individuals to communicate with the mice and keyboards, useful input devices, for the computer applications. However, it is not convenient to operate the conventional optical mice as pen-writing way for their bulky configurations. Therefore, pen-shaped mice provided on the market and try to solve these problems caused by structure and shape of mice.

A pen-shaped optical mouse is an input device of the computer and the operating principle described as below. There is a light emitting diode (LED) in the optical mouse. The light of the LED is projected to the surface plane below the mouse and the light reflection is transmitted through optical lens to an optical sensor for the image formation. Therefore, the moving tracks are recorded as a series of images when the optical mouse is moved across the surface plane. Consequently, the series of images of the moving tracks are processed by the CPU of the optical mouse, and the changes of positions and optical characteristics are analyzed to determine the directions and distances of the mouse motion to locate the cursor.

U.S. Pat. No. 7,053,358 B2 published on May 30, 2006, titled “Method and Apparatus for Real-Time Determining Compatibility of a Working Surface with an Optical Mouse” disclosed an optical mouse including an optical sensor to sense the optical characteristics of the working surface, a judging circuit to judge the compatibility of the working surface with the optical mouse according to the optical characteristics sensed by the optical sensor, and a display device electrically connected to the judging circuit for displaying the compatibility of the working surface with the optical mouse.

Considering that there is a disadvantage for the conventional mouse, incident light would not been passed through opaque working surface thereof when the mouse is operated, then completely reflected to the optical sensor of the optical mouse and the signal is received by the optical sensor, consequently the pointing function operated correctly. If the working surface was transparent, the incident light would be partially passed through the working surface and reflected to the optical sensor in part. Thus, the light reflection signal could not be received completely so that the pointing function operated incorrectly.

### SUMMARY OF THE INVENTION

The primary objective of the present invention is to provide a pen-type optical input device, which is easily grasped with a hand and obviated the limit of light reflection to be manipulated with more convenience.

Another objective of the present invention is to provide a pen-type optical input device including a pressure sensor for sensing the loading of pen nib to determine and control the degree of thickness of line when used.

To achieve the objectives of the present invention, the pen-type optical input device is provided for controlling the cursor of operating system of electronic device. The pen-type optical input device comprises a main body, a circuit board, and a ball. The main body includes a front end cap and a tail end cap, wherein the front end cap is an inverted cone, and the circuit board, set in the main body, has an optical sensor and a pressure sensor. The ball is installed at the front end of the pen-type optical input device, furthermore, it is disposed in and partially protruding out of the front end cap and in alignment with holders at both sides, wherein each holder further includes a contact roller to contact with the ball. The contact roller is utilized to stabilize the ball rolling and secure the ball against dropping out of the front end cap when the ball is rolled across an axis plane.

Additionally, the optical sensor is disposed above the ball to project light on the ball surface directly, and the light reflection is received by the optical sensor to determine the movement and speed of the cursor when the ball is rolled on the axis plane. Accordingly, the axis plane does not have to be opaque and reflective for light reflection because the ball is located between the light source and axis plane. Thus, it is more convenient to use the pen-type optical input device whether the axis plane is transparent or not.

Moreover, the pressure sensor is installed at the front end of the pen-type optical input device and extended from the circuit board. The pressure sensor is set to contact one end of the ball for sensing the ball loading to determine and control the degree of thickness of lines when the input device is used. The optical input device of the present invention further includes an illuminated unit that is a laser emitting unit. The laser beam emitted from the illuminated unit is subsidiary for the optical sensor to detect light signals.

### BRIEF DESCRIPTIONS OF THE DRAWINGS

The foregoing aspects, as well as many of the attendant advantages and features of this invention will become more apparent by reference to the following detailed description, when taken in conjunction with the accompanying drawings, wherein:

FIG. 1 illustrates the longitudinal sectional view of the preferred embodiment;

FIG. 2 illustrates the longitudinal sectional view of the front end of the preferred embodiment;

FIG. 3 illustrates the longitudinal sectional view of the front end of another embodiment; and

FIG. 4 illustrates the longitudinal sectional view of the front end of another embodiment.

### DETAILED DESCRIPTIONS OF THE PREFERRED EMBODIMENT

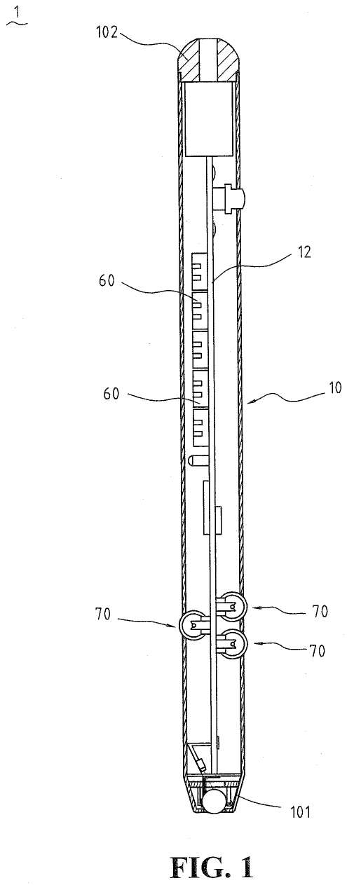

Referring to FIG. 1 to illustrate the longitudinal sectional view of the preferred embodiment. The pen-type optical input device 1 is mainly composed of a main body 10. The main body 10 includes a front end cap 101 and a tail end cap 102, and there is a circuit board 12 mounted inside the main body 10. The circuit board 12 is electrically connected with a plurality of units such as a battery 60 and a cursor controller 70, wherein the battery 60 adapted to provide power for the optical input device 10 and the cursor controller 70 utilized as left/right keys of common mice. They are conventional techniques so that there is no detailed description here.

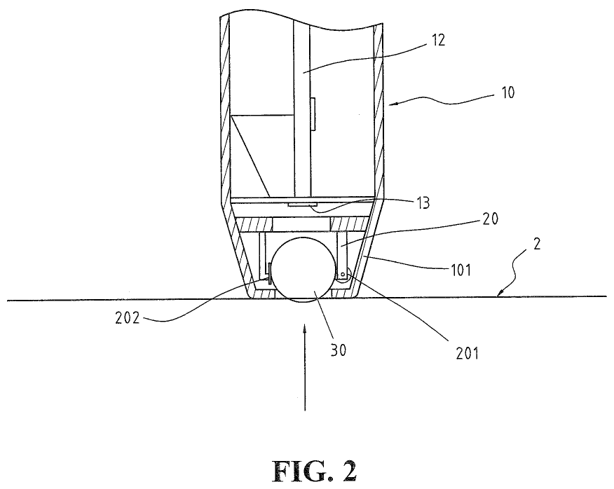

Subsequently, with reference to FIG. 2 showing the longitudinal sectional view of the front end of the preferred embodiment. The pen-type optical input device 1 for controlling the cursor of operating system of electronic device comprises a main body 10, a circuit board 12, and a ball 30. The main body 10 is specified as a pen-type hollow tube complying with ergonomics, and has a front end cap 101 and tail end cap 102 at both ends, wherein the both caps are threaded into both ends of the main body 10. Besides, the circuit board 12 is mounted inside the main body 10, and an optical sensor 13 installed on the circuit board 12 for detecting optical signals. The ball 30, which is an opaque material disposed in the front end cap 101, partially protrudes out of the front end cap 101 and in alignment with holders 20 at both sides.

In addition, the optical sensor 13 is disposed above the ball 30 to sense the motion of the ball 30. Instead of the axis plane, the light is projected directly on the surface of the ball 30 by the optical sensor 13, and the light reflection is also received by the optical sensor 13 to determine the movement and speed of the cursor when the ball 30 is rolled. Thus, the axis plane 2 does not have to be opaque and reflective for light reflection because the ball 30 is located between the light source and axis plane 2. As a result, it is more convenient to use the pen-type optical input device 1 whether the axis plane 2 is transparent or not.

Moreover, the holders 20 further include contact rollers 201, 202 to contact with the ball 30 to stabilize the ball rolling and secure the ball 30 against dropping out of the front end cap 101 when the ball 30 is rolled across an axis plane 2.

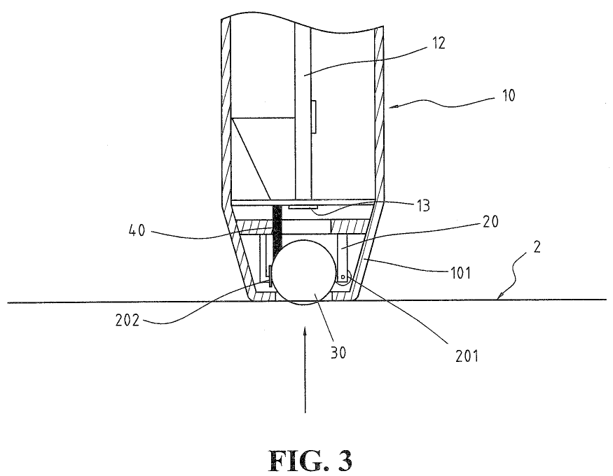

Referring to FIG. 3 to illustrate the longitudinal sectional view of the front end of another embodiment. To facilitate draftsmen in drawing or writing, a pressure sensor 40 is installed on the circuit board 12. Because the front end cap 101 is an inverted cone structure, the pressure sensor 40 could be set extendedly on the front end of the circuit board 12 to contact the ball 30 which is in the front end cap 101. In this way, the pressure sensor 40 is utilized for sensing the ball loading to determine and control the degree of thickness of lines when the invention is used.

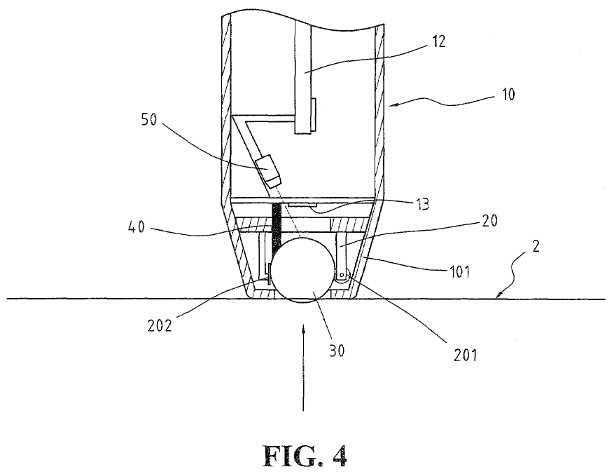

With reference to FIG. 4, it shows the longitudinal sectional view of the front end of another embodiment. As shown in this figure, there is further an illuminated unit 50, subsidiary for the optical sensor 13, installed at the front end of the circuit board 12, and the illuminated unit 50 is a laser emitting unit. According to the present invention, the main body 10 is moved by rubbing against the axis plane 2 to roll the ball 30, at the same time, the light is projected directly on the surface of the ball 30 by the optical sensor 13, and the reflected light is received by the optical sensor 13 to determine the movement and speed of the cursor. Meanwhile, the illuminated unit 50 also projects light on the ball 30 to enhance optical signals and facilitate the operational efficiency.

Accordingly, the pen-type optical input device of the present invention provides the following characteristics.

First, it is shaped like a pen for easy use, and the opaque ball set between the light source and axis plane provides a solution for the restriction of light reflection. Thus, it is more convenient to use the pen-type optical input device whether the axis plane is transparent or not.

Second, the pressure sensor is set for sensing the loading of pen nib to determine and control the degree of thickness of line while drawing. Additionally, the illuminated unit, subsidiary for the optical sensor, is further installed to enhance the optical signals and improve the operational efficiency.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A pen-type optical input device for controlling the cursor of operating system of electronic device, comprising:
a main body, including a front end cap and a tail end cap;
a circuit board, set in the main body, having an optical sensor; and
a ball, partially protruding out of the front end cap and in alignment with holders at both sides;
the characteristic is that the optical sensor disposed above the ball to project light on the ball surface directly, and the light reflection received by the optical sensor to determine the movement and speed of the cursor when the ball rolled.

2. The pen-type optical input device of claim 1, further include a pressure sensor on the front end of circuit board.

3. The pen-type optical input device of claim 1, wherein the front end cap is an inverted cone structure.

4. A pen-type optical input device for controlling the cursor of operating system of electronic device, comprising:
a main body, including a front end cap and a tail end cap;
a circuit board, set in the main body, having an optical sensor, a pressure sensor and an illuminated unit; and
a ball, partially protruding out of the front end cap and in alignment with holders at both sides;
the characteristic is that the optical sensor and the illuminated unit disposed above the ball to project light on the ball surface directly, and the light reflection received by the optical sensor to determine the movement and speed of the cursor when the ball rolled.

5. The pen-type optical input device of claim 4, wherein the illuminated unit is a laser emitting unit.

6. The pen-type optical input device of claim 1, wherein the optical sensor disposed above the ball for sensing the ball motion, and the pressure sensor set to contact one end of the ball for sensing the ball loading.

7. The pen-type optical input device of claim 1, wherein the holder further includes a contact roller to contact the ball.

8. The pen-type optical input device of claim 4, wherein the optical sensor disposed above the ball for sensing the ball motion, and the pressure sensor set to contact one end of the ball for sensing the ball loading.

9. The pen-type optical input device of claim 4, wherein the holder further includes a contact roller to contact the ball.
